(19) United States
(12) Patent Application Publication
(10) Pub. No.: US 2023/0369585 A1
(43) Pub. Date: Nov. 16, 2023

(54) SACRIFICIAL ADDITIVE MATERIALS FOR PRODUCING EXCESS LI-IONS IN RECHARGEABLE BATTERIES

(71) Applicant: Rivian IP Holdings, LLC, Irvine, CA (US)

(72) Inventors: Soo Kim, Fremont, CA (US); Byoungchul You, Saratoga, CA (US); Cary Hayner, Naperville, IL (US); Ki Tae Park, Santa Clara, CA (US)

(21) Appl. No.: 17/741,665

(22) Filed: May 11, 2022

(51) Int. Cl. H01M 4/58; H01M 10/0525; H01M 10/0563

(52) U.S. Cl. CPC H01M 4/58; H01M 10/0525; H01M 10/0563; H01M 2300/002

(57) ABSTRACT

An electrode includes an electrode active material and a lithium generating species including a mixture of Li₃N and MNₓ, wherein MNₓ is a metal nitride including a metal (M) selected from Na, K, Ca, Mg, Ba, V, Nb, Ti, Zr, and Sr, or a mixture of any two or more thereof.

### INTRODUCTION

The present technology is generally related to lithium rechargeable batteries. More particularly the technology relates to sacrificial additives that may be added to the cathode or anode to supply additional lithium ions or enhance the SEI layer.

### SUMMARY

In one aspect, an electrode includes an electrode active material and a lithium generating species that includes a mixture of Li₃N and MNₓ, wherein MNₓ may be a metal nitride where the metal (M) may comprise Na, K, Ca, Mg, Ba, V, Nb, Ti, Zr, or Sr, or a mixture of any two or more thereof. In some embodiments, the MNₓ may be Ba₃N₂, NaN₃, KN₃, VN, NbN, TiN, ZrN, Sr₃N₂, Ca₃N₂, or Mg₃N₂, or a mixture of any two or more thereof.

In another aspect, a battery includes comprising the above electrode, a counter electrode, and an electrolyte comprising a halogen-containing species. In some embodiments, the electrode may be a cathode and the counter electrode an anode. In any of the above embodiments, the halogen-containing species is a fluoride-containing compound. In such embodiments, the fluoride-containing compound may be HF.

In one aspect, a cathode for a lithium ion battery includes a cathode active material and coating of a ternary lithium metal oxide, a ternary lithium transition metal phosphate, or a mixture thereof, wherein the metal of the ternary lithium metal oxide may comprise Ti, Mo, Mn, Co, Fe, Bi, W, or Ni, or a mixture of any two or more thereof; and the transition metal of the ternary lithium transition metal phosphate may comprise V or Cr, or a mixture thereof. In some embodiments, the ternary lithium metal oxide may comprise LiTiO₂, LiMoO₂, Li₇Ti₁₁O₂₄, Li₆MnO₄, Li₆CoO₄, Li₅Ti₃O₈, Li₂CoO₂, Li₆FeO₄, Li₈BiO₆, LiW₂O₆, or Li₆NiO₄, or a mixture of any two or more thereof. In any such embodiments, the ternary lithium transition metal phosphate may include LiVPO₄ or LiCrPO₄, or a mixture thereof. In another aspect, a battery is provided that include any of the cathodes described herein.

In a further aspect, a method of producing an electrode having a protective coating includes forming in a liquid medium a slurry including an electrode active material and a lithium generating species including a mixture of Li₃N and MNₓ, wherein MNₓ is a metal nitride where the metal (M) may comprise Na, K, Ca, Mg, Ba, V, Nb, Ti, Zr, or Sr, or a mixture of any two or more thereof; applying the slurry to a current collector; removing the liquid medium to form an electrode; immersing the electrode in an electrolyte comprising a halogen-containing species; and applying a voltage to the electrode to generate an electrode having a protective coating; wherein: protective coating comprises a reaction product of the Li₃N, MNₓ, and the halogen-containing species; the protective coating is electrically insulating and ionically conductive. In some embodiments, the halogen-containing species is HF.

Such batteries may comprise a bank of battery cells, a power unit in a vehicle, or a battery or battery cell within an electric vehicle. In further aspect, an electric vehicle comprises any of the batteries or battery cells embodied herein.

### BRIEF DESCRIPTION OF THE DRAWINGS

FIG. 1 is a reaction profile graph for NaN₃ and Li₃N, showing no reaction, according to the examples.

FIG. 2 is a reaction profile graph for VN and Li₃N, which illustrates the release of Li⁺ ions and the formation of a new ternary Li-M-N compound upon chemical reaction, according to the examples.

FIG. 3 is a schematic diagram showing the utilization of metal nitride materials with Li₃N on the electrode surface, according to the examples.

FIG. 4 is a schematic illustration of a Type I reaction to access the Li⁺ ions from Li₃N and to form protective MFₓ from other nitride compounds that phase separate with Li₃N, according to some embodiments.

FIG. 5 is a schematic illustration of a Type II reaction to produce excess Li ions before the formation of stable Li-M-N compounds by reacting binary metal fluoride with Li₃N, according to various embodiments.

FIG. 6 is a schematic illustration of a Type III reaction that does not produce excess Li but produces protective fluoride materials, according to various embodiments.

FIG. 7 is a graph of the two step conversion of LiTiO₂ to TiO₂ upon charging, where the lower plateau on the right (i.e., x=1 to x=0.5) shows the LiTiO₂ to Li_{0.5}TiO₂ reaction occurring at 1.29 V vs. Li/Li⁺, while the upper plateau on the left (i.e., x=0.5 to x=0) shows Li_{0.5}TiO₂ to Li_{0.5}TiO₂ reaction that occurs at 1.57 V vs. Li/Li⁺, and on average, the LiTiO₂ to TiO₂ net reaction takes place at 1.43 vs. Li/Li⁺, as shown in Table 9 of the examples.

FIG. 8 is a graph illustrating the one-step reaction of LiVPO₄ to VPO₄, and occurring at 2.25 V vs. Li/Li⁺, according to the examples.

FIG. 9 is a schematic illustration of the production of Li⁺ and a stable coating material using the example of LiTiO₂ to generate Li⁺ and a stable TiO₂ coating.

FIG. 10 is a schematic illustration of a cell stack showing the activation of lithium generating species, according to various embodiments.

FIG. 11 is an illustration of a cross-sectional view of an electric vehicle, according to various embodiments.

FIG. 12 is a depiction of an illustrative battery pack, according to various embodiments.

FIG. 13 is a depiction of an illustrative battery module, according to various embodiments.

FIGS. 14A, 14B, and 14C are cross sectional illustrations of various batteries, according to various embodiments.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

It has now been found that a mixture of Li₃N and binary nitride (MNₓ) materials at the battery electrode surfaces may decompose to Li⁺ ions and other stable phase(s) that can provide beneficial properties to a battery in which they are incorporated. In some instances, the Li₃N and MNₓ may react to form a ternary Li-M-N compound as an intermediate species. Upon battery cell formation and activation, nitrogen or ammonia may be evolved due during the decomposition reactions. The remaining ions may then scavenge the available HF that may be present due to electrolyte decomposition, the scavenging of which can further lead to the formation of protective coating layer at the electrode surfaces.

In lithium ion batteries, fresh anode electrode surfaces consume a portion of the Li⁺ ions that are transported from the cathode side during the first few cycles of operation to form a stable, passivating solid electrolyte interface, or “SEI.” If the anode surface area is higher (e.g., high surface area carbon, etc.), then a larger volume of SEI will form, trapping more Li⁺ ions from the cathode side. These trapped Li⁺ ions are no longer reversible for the rechargeable battery, leading to a significant decrease for the overall cell energy density. One strategy to account for the Li⁺ ion loss is to use a “cathode additive” with a high concentration of Li⁺ ions that can supply excess amount of Li ion sources. Using Li₃N as a “sole” cathode additive can balance the Li⁺ loss through N₂ gas evolution during the 1^{st} cycle formation cycle. The N₂ can be vented from the cell to prevent pressure build-up. Here, it has been found that by adding MNK species with the LiN₃, enhanced SEI layers may be formed, as well as providing protective metal fluoride coatings and other ternary lithium metal oxides to protect the electrode active materials. It has also been found that similar result, but without the generation of N₂ or other gases, may be achieved by adding a ternary transition metal oxide to the electrodes, which, upon charging, decomposes into Li⁺ and a transition metal oxide that is stable on the surface of, and protective of, the electrode active material.

In a first aspect, an electrode for a lithium ion battery includes an electrode active material and a lithium generating species. The lithium generating species may include a mixture of Li₃N and MNₓ, wherein MNₓ is a metal nitride that includes a metal (M) selected from Na, K, Ca, Mg, Ba, V, Nb, Ti, Zr, Sr, or a mixture of any two or more thereof. In other aspects, the electrode may include a coating of a ternary lithium metal oxide, wherein the metal is Ti, Mo, Mn, Co, Fe, Bi, W, or Ni, or a mixture of any two or more thereof, and/or a ternary lithium transition metal phosphate, wherein the transition metal is V or Cr, or a mixture thereof. Such coatings may be stand-alone or in conjunction with the lithium generating species.

Where the lithium generating species includes a mixture of Li₃N and MNₓ, the metal nitride contains one or more metals (M) selected from Na, K, Ca, Mg, Ba, V, Nb, Ti, Zr, and Sr. In various embodiments, the MNₓ may be any one or more metal nitrides selected from Ba₃N₂, NaN₃, KN₃, VN, NbN, TiN, ZrN, Sr₃N₂, Ca₃N₂, and Mg₃N₂. It is to be noted that the value of x (in the MNₓ) is not provided as it is merely a designation of a metal nitride, the stoichiometry of which may vary and be fractional amounts when normalized to the amount of “M” to be recited. Accordingly, to the extent definition is required it may be from greater than 0 to about 5, including fractional amounts, depending on the stoichiometric ratio of the nitrogen to the metal. Even higher amounts can be expressed as fractional amounts if the metal is normalized to 1.

In some embodiments, the metal nitride is Ba₃N₂, NaN₃, or KN₃, or a combination of any two or more thereof. In such embodiments, a molar ratio of Li₃N to MNₓ may be from greater than 0 to about 1. Here, the molar ratio in such embodiment may be greater than about 3, from 2 to 10, from 2 to 8, from 2 to 6, from 2 to 4, about 2, about 3, about 4, about 5, about 6, about 7, about 8, about 9, or about 10. In other embodiments, the MNₓ may be VN, NbN, TiN, or ZrN, or a combination of any two or more thereof. In such embodiments, a molar ratio of Li₃N to MNₓ may be greater than about 2. For example, the molar ratio in such embodiment may be greater than about 3, from 2 to 10, from 2 to 8, from 2 to 6, from 2 to 4, about 2, about 3, about 4, about 5, about 6, about 7, about 8, about 9, or about 10. In still other embodiments, MNₓ may be Sr₃N₂, Ca₃N₂, or Mg₃N₂, or a combination of any two or more thereof. In such embodiments, a molar ratio of Li₃N to MNₓ may be greater than about 0.5. For example, the molar ratio in such embodiment may be greater than about 0.75, greater than about 1, from 0.5 to 10, from 0.5 to 8, from 0.5 to 6, from 0.5 to 4, about 0.5, about 0.75, about 1, about 2, about 3, about 4, or about 5.

Where the electrode includes a lithium generating species that is a ternary lithium metal oxide, and the ternary lithium metal oxide may be one or more of LiTiO₂, LiMoO₂, Li₇Ti₁₁O₂₄, Li₆MnO₄, Li₆CoO₄, Li₅Ti₃O₈, Li₂CoO₂, Li₆FeO₄, Li₈BiO₆, LiW₂O₆, and Li₆NiO₄. In some embodiments, the lithium generating species may be one or more of LiTiO₂, LiMoO₂, LiVPO₄, and LiCrPO₄.

Where the electrode includes a lithium generating species that is a ternary lithium transition metal phosphate, the ternary lithium transition metal phosphate may be one or both of LiVPO₄ and LiCrPO₄.

The electrode that includes the lithium generating species may be a cathode or an anode. Where the electrode is present in a battery cell, the electrode that includes the lithium generating species may be a cathode, an anode, or both the cathode and anode. Where the electrode is a cathode, it may contain a cathode active material. Illustrative cathode active materials include, but are not limited to, LiFePO₄, LiMnₓFe₁₋ₓPO₄, LiMn₂O₄, LiNi_{0.5}Mn_{1.5}O₄, Li₁₊ₓM₁₋ₓO₂, Li(NiₐMn_{b}Co_{c}Al_{d})O₂, or a mixture of any two or more thereof, wherein 0<x<1, and a+b+c+d=1). Where the electrode is an anode, it may contain an anode active material. Illustrative anode active materials include, but are not limited to, Li metal, graphite, Si, SiOₓ, Si nanowire, lithiated Si, or a mixture of any two or more thereof.

The electrode as described herein may contain from about 0.1 wt % to about 15 wt % of the lithium generating species. For example, the electrode as described herein may contain from about 0.5 wt % to about 5 wt %, or about 1 wt % to about 3 wt % of the lithium generating species.

The electrodes may also contain other materials such as conductive carbon materials, current collectors, binders, and other additives. Illustrative conductive carbon species include graphite, carbon black, Super P carbon black material, Ketjen Black, Acetylene Black, SWCNT, MWCNT, graphite, carbon nanofiber, and/or graphene, graphite. Illustrative binders may include, but are not limited to, polymeric materials such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The cathode current collector may include a metal that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiments, the current collector is a metal alloy, made of Al, Cu, Ni, Fe, Ti, or combination thereof. In another embodiment, the metal foils maybe coated with carbon: e.g., carbon-coated Al foil, and the like. In some embodiments, the electrode may comprise a current collector (e.g., Cu foil) with an in situ-formed anode (e.g., Li metal) on a surface of the current collector facing the separator or solid-state electrolyte such that in an uncharged state, the assembled cell does not comprise an anode active material.

In another aspect, a method of introducing the lithium generating species that includes a mixture of the LiN₃ and MNₓ to the electrode is provided. The method includes suspending a cathode or anode active material with the LiN₃ and MNₓ in a solvent to form a slurry, coating the slurry on a current collector, and then driving off the solvent to leave a coated current collector as the electrode. The slurry may also include one or more conductive carbons, binders, and other additives. The MNₓ may be a metal nitride including one or more metals (M) selected from Na, K, Ca, Mg, Ba, V, Nb, Ti, Zr, and Sr.

Where the lithium generating species is the lithium transition metal oxide or phosphate, a method of introducing the lithium generating species to the electrode or the electrode active material is provided. However, here the lithium transition metal oxide/phosphate may be separately generated and mixed with the cathode or anode active material as described above, or it may include adding lithium transition metal oxide/phosphate precursors to the cathode or anode active material to form a mixture, and sintering the mixture to generate the cathode or anode active material surface-coated with a lithium transition metal oxide or phosphate.

Where the lithium generating species is the lithium transition metal oxide or phosphate, a method of introducing the lithium generating species to the electrode or the electrode active material may also include depositing on the electrode material a lithium transition metal oxide or phosphate using the appropriate stoichiometric ratios of the metal constituents of the layer via chemical vapor deposition (CVD), physical vapor deposition (PVD), pulsed laser deposition (PLD), emulsion, sol-gel, atomic layer deposition (ALD), and/or other deposition techniques. For example, a lithium transition metal oxide or phosphate may be deposited via ALD using precursor materials containing lithium, the metal or metal oxide, and a phosphorus source. In one embodiment, the target precursors are dissolved in H₂O and/or organic solvent such EtOH, acetone, methanol, isopropyl alcohol (IPA), and the like, and then slowly evaporating the solvent to form the lithium transition metal oxide or phosphate during the calcination process.

Illustrative conductive carbon species for use in the methods include, but are not limited to, graphite, carbon black, Super P carbon black material, Ketjen Black, Acetylene Black, SWCNT, MWCNT, graphite, carbon nanofiber, and/or graphene, graphite. Illustrative binders include, but are not limited to, polymeric material such as polyvinylidenefluoride (“PVDF”), polyvinylpyrrolidone (“PVP”), styrene-butadiene or styrene-butadiene rubber (“SBR”), polytetrafluoroethylene (“PTFE”) or carboxymethylcellulose (“CMC”). Other illustrative binder materials can include one or more of: agar-agar, alginate, amylose, Arabic gum, carrageenan, caseine, chitosan, cyclodextrines (carbonyl-beta), ethylene propylene diene monomer (EPDM) rubber, gelatine, gellan gum, guar gum, karaya gum, cellulose (natural), pectine, poly(3,4-ethylenedioxythiophene) polystyrene sulfonate (PEDOT-PSS), polyacrilic acid (PAA), poly(methyl acrylate) (PMA), poly(vinyl alcohol) (PVA), poly(vinyl acetate) (PVAc), polyacrylonitrile (PAN), polyisoprene (Plpr), polyaniline (PANi), polyethylene (PE), polyimide (PI), polystyrene (PS), polyurethane (PU), polyvinyl butyral (PVB), polyvinyl pyrrolidone (PVP), starch, styrene butadiene rubber (SBR), tara gum, tragacanth gum, fluorine acrylate (TRD202A), xanthan gum, or mixtures of any two or more thereof. The solvent used in the slurry formation may be a ketone, an ether, a heterocyclic ketone, and/or distilled water. One illustrative solvent is N-methylpyrrolidone (“NMP”). The solvent may be removed by allowing the solvent to evaporate at ambient or elevated temperature, or at ambient pressure or reduced pressure. Handling of the cathode and other lithium ion battery internal components may be conducted under an inert atmosphere (N₂, He, Ag, etc.), according to some embodiments. The cathode current collector may include a metal that is that is aluminum, copper, nickel, titanium, stainless steel, or carbonaceous materials. In some embodiments, the metal of the current collector is in the form of a metal foil. In some specific embodiments, the current collector is an aluminum (Al) or copper (Cu) foil. In some embodiment, the current collector is a metal alloy, made of Al, Cu, Ni, Fe, Ti, or combination thereof. In another embodiment, the metal foils maybe coated with carbon: e.g., carbon-coated Al foil, etc.

The active material may be loaded onto the current collector such that after solvent removal coverage is from about 5 mg/cm² to about 50 mg/cm² (“Loading Level”), and the packing density may vary from about 1.0 g/cc to about 5.0 g/cc. More specifically, the loading level may be about 15 mg/cm² to 35 mg/cm². The electrode packing density may be greater than 2.0 g/cc, approaching 4.0 g/cc.

In a further aspect, a battery cell is provided that includes a cathode, an anode, an electrolyte, and, optionally a separator between the cathode and anode, wherein the cathode, the anode, or both the cathode and the anode include a lithium generating species as described above. For example, the lithium generating species may be include a mixture of Li₃N and MNₓ, a ternary lithium metal oxide as described above, a ternary lithium transition metal phosphate as described above, or a mixture of any two or more thereof. In the battery cell, the electrolyte may be a solution phase electrolyte or a solid-state electrolyte. Solution phase electrolytes may include a lithium salt such as lithium hexafluorophosphate (LiPF₆), lithium tetrafluoroborate (LiBF₄), lithium perchlorate (LiClO₄), lithium bis-trifluoromethanesulfonimide (LiTFSI), or lithium difluoro(oxalate)borate (LiDFOB), and a carbonate solvent such as a dimethyl carbonate (DMC), ethylene carbonate (EC), and diethyl carbonate (DEC), among others. Solid-state electrolytes may include a metal oxide, a metal sulfide, or a metal phosphate crystalline structure that is electronically insulating but ionically conductive (i.e., allows lithium-ion migration). Such battery cells may be prismatic, cylindrical, or pouch type cells.

In another aspect, the present disclosure provides a battery pack comprising the cathode active material, the electrochemical cell, or the lithium ion battery of any one of the above embodiments. The battery pack may find a wide variety of applications including but are not limited to general energy storage or in vehicles.

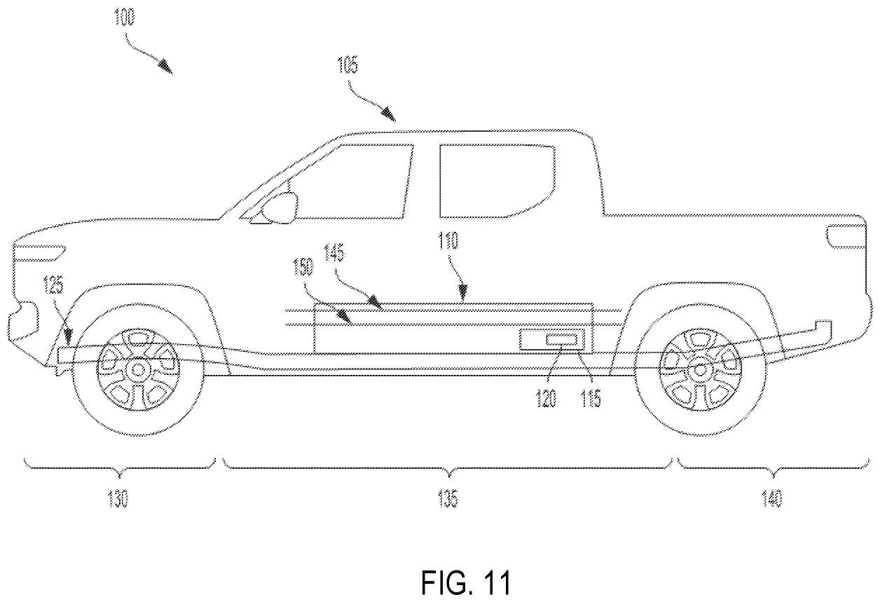

In another aspect, a plurality of battery cells as described above may be used to form a battery and/or a battery pack, that may find a wide variety of applications such as general storage, or in vehicles. By way of illustration of the use of such batteries or battery packs in an electric vehicle, FIG. 11 depicts is an example cross-sectional view 100 of an electric vehicle 105 installed with at least one battery pack 110. Electric vehicles 105 can include electric trucks, electric sport utility vehicles (SUVs), electric delivery vans, electric automobiles, electric cars, electric motorcycles, electric scooters, electric passenger vehicles, electric passenger or commercial trucks, hybrid vehicles, or other vehicles such as sea or air transport vehicles, planes, helicopters, submarines, boats, or drones, among other possibilities. The battery pack 110 can also be used as an energy storage system to power a building, such as a residential home or commercial building. Electric vehicles 105 can be fully electric or partially electric (e.g., plug-in hybrid) and further, electric vehicles 105 can be fully autonomous, partially autonomous, or unmanned. Electric vehicles 105 can also be human operated or non-autonomous. Electric vehicles 105 such as electric trucks or automobiles can include on-board battery packs 110, battery modules 115, or battery cells 120 to power the electric vehicles. The electric vehicle 105 can include a chassis 125 (e.g., a frame, internal frame, or support structure). The chassis 125 can support various components of the electric vehicle 105. The chassis 125 can span a front portion 130 (e.g., a hood or bonnet portion), a body portion 135, and a rear portion 140 (e.g., a trunk, payload, or boot portion) of the electric vehicle 105. The battery pack 110 can be installed or placed within the electric vehicle 105. For example, the battery pack 110 can be installed on the chassis 125 of the electric vehicle 105 within one or more of the front portion 130, the body portion 135, or the rear portion 140. The battery pack 110 can include or connect with at least one busbar, e.g., a current collector element. For example, the first busbar 145 and the second busbar 150 can include electrically conductive material to connect or otherwise electrically couple the battery modules 115 or the battery cells 120 with other electrical components of the electric vehicle 105 to provide electrical power to various systems or components of the electric vehicle 105.

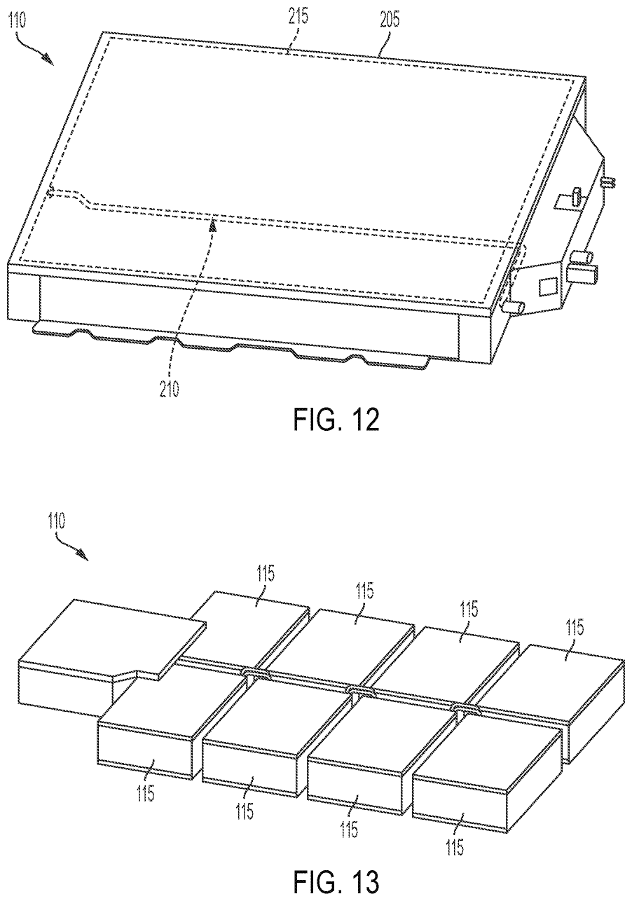

FIG. 12 depicts an example battery pack 110. Referring to FIG. 12, among others, the battery pack 110 can provide power to electric vehicle 105. Battery packs 110 can include any arrangement or network of electrical, electronic, mechanical or electromechanical devices to power a vehicle of any type, such as the electric vehicle 105. The battery pack 110 can include at least one housing 205. The housing 205 can include at least one battery module 115 or at least one battery cell 120, as well as other battery pack components. The housing 205 can include a shield on the bottom or underneath the battery module 115 to protect the battery module 115 from external conditions, for example if the electric vehicle 105 is driven over rough terrains (e.g., off-road, trenches, rocks, etc.) The battery pack 110 can include at least one cooling line 210 that can distribute fluid through the battery pack 110 as part of a thermal/temperature control or heat exchange system that can also include at least one thermal component (e.g., cold plate) 215. The thermal component 215 can be positioned in relation to a top submodule and a bottom submodule, such as in between the top and bottom submodules, among other possibilities. The battery pack 110 can include any number of thermal components 215. For example, there can be one or more thermal components 215 per battery pack 110, or per battery module 115. At least one cooling line 210 can be coupled with, part of, or independent from the thermal component 215.

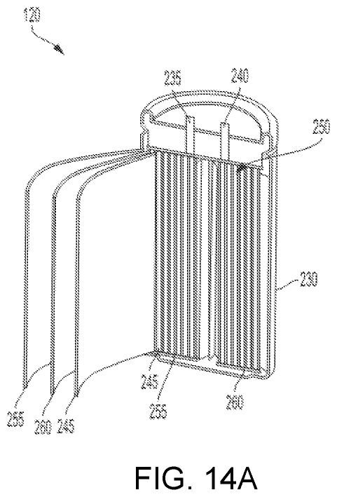

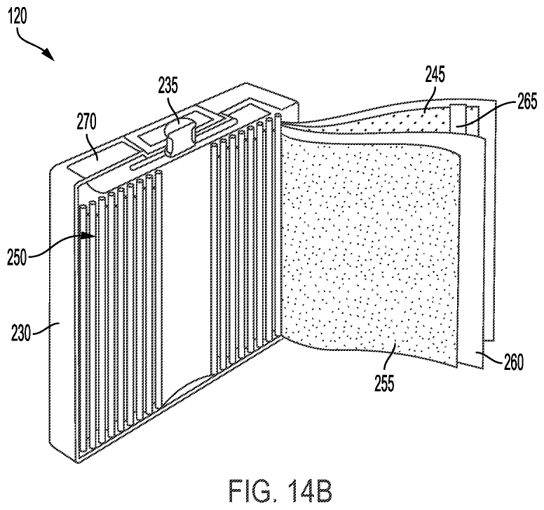

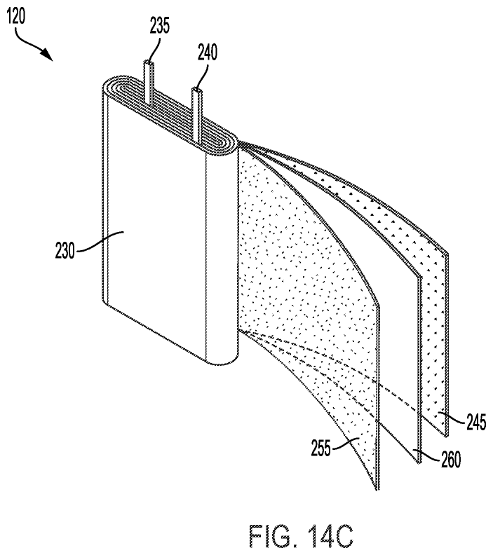

FIG. 13 depicts example battery modules 115, and FIGS. 14A, 14B, and 14C depict illustrative cross sectional views of battery cells 120 in various forms. For example FIG. 14A is a cylindrical cell, 14B is a prismatic cell, and 14C is the cell for use in a pouch. The battery modules 115 can include at least one submodule. For example, the battery modules 115 can include at least one first (e.g., top) submodule 220 or at least one second (e.g., bottom) submodule 225. At least one thermal component 215 can be disposed between the top submodule 220 and the bottom submodule 225. For example, one thermal component 215 can be configured for heat exchange with one battery module 115. The thermal component 215 can be disposed or thermally coupled between the top submodule 220 and the bottom submodule 225. One thermal component 215 can also be thermally coupled with more than one battery module 115 (or more than two submodules 220, 225). The battery submodules 220, 225 can collectively form one battery module 115. In some examples each submodule 220, 225 can be considered as a complete battery module 115, rather than a submodule.

The battery modules 115 can each include a plurality of battery cells 120. The battery modules 115 can be disposed within the housing 205 of the battery pack 110. The battery modules 115 can include battery cells 120 that are cylindrical cells, prismatic cells, or pouch cells, for example. The battery module 115 can operate as a modular unit of battery cells 120. For example, a battery module 115 can collect current or electrical power from the battery cells 120 that are included in the battery module 115 and can provide the current or electrical power as output from the battery pack 110. The battery pack 110 can include any number of battery modules 115. For example, the battery pack can have one, two, three, four, five, six, seven, eight, nine, ten, eleven, twelve or other number of battery modules 115 disposed in the housing 205. It should also be noted that each battery module 115 may include a top submodule 220 and a bottom submodule 225, possibly with a thermal component 215 in between the top submodule 220 and the bottom submodule 225. The battery pack 110 can include or define a plurality of areas for positioning of the battery module 115. The battery modules 115 can be square, rectangular, circular, triangular, symmetrical, or asymmetrical. In some examples, battery modules 115 may be different shapes, such that some battery modules 115 are rectangular but other battery modules 115 are square shaped, among other possibilities. The battery module 115 can include or define a plurality of slots, holders, or containers for a plurality of battery cells 120.

Battery cells 120 have a variety of form factors, shapes, or sizes. For example, battery cells 120 can have a cylindrical, rectangular, square, cubic, flat, or prismatic form factor. Battery cells 120 can be assembled, for example, by inserting a winded or stacked electrode roll (e.g., a jellyroll) including electrolyte material into at least one battery cell housing 230. The electrolyte material, e.g., an ionically conductive fluid or other material, can generate or provide electric power for the battery cell 120. A first portion of the electrolyte material can have a first polarity, and a second portion of the electrolyte material can have a second polarity. The housing 230 can be of various shapes, including cylindrical or rectangular, for example. Electrical connections can be made between the electrolyte material and components of the battery cell 120. For example, electrical connections with at least some of the electrolyte material can be formed at two points or areas of the battery cell 120, for example to form a first polarity terminal 235 (e.g., a positive or anode terminal) and a second polarity terminal 240 (e.g., a negative or cathode terminal). The polarity terminals can be made from electrically conductive materials to carry electrical current from the battery cell 120 to an electrical load, such as a component or system of the electric vehicle 105.

For example, the battery cell 120 can include lithium-ion battery cells. In lithium-ion battery cells, lithium ions can transfer between a positive electrode and a negative electrode during charging and discharging of the battery cell. For example, the battery cell anode can include lithium or graphite, and the battery cell cathode can include a lithium-based oxide material. The electrolyte material can be disposed in the battery cell 120 to separate the anode and cathode from each other and to facilitate transfer of lithium ions between the anode and cathode. It should be noted that battery cell 120 can also take the form of a solid state battery cell developed using solid electrodes and solid electrolytes. Yet further, some battery cells 120 can be solid state battery cells and other battery cells 120 can include liquid electrolytes for lithium-ion battery cells.

The battery cell 120 can be included in battery modules 115 or battery packs 110 to power components of the electric vehicle 105. The battery cell housing 230 can be disposed in the battery module 115, the battery pack 110, or a battery array installed in the electric vehicle 105. The housing 230 can be of any shape, such as cylindrical with a circular (e.g., as depicted), elliptical, or ovular base, among others. The shape of the housing 230 can also be prismatic with a polygonal base, such as a triangle, a square, a rectangle, a pentagon, and a hexagon, among others. The housing 230 can be rigid or not rigid (e.g., flexible).

The housing 230 of the battery cell 120 can include one or more materials with various electrical conductivity or thermal conductivity, or a combination thereof. The electrically conductive and thermally conductive material for the housing 230 of the battery cell 120 can include a metallic material, such as aluminum, an aluminum alloy with copper, silicon, tin, magnesium, manganese, or zinc (e.g., aluminum 1000, 4000, or 5000 series), iron, an iron-carbon alloy (e.g., steel), silver, nickel, copper, and a copper alloy, among others. The electrically insulative and thermally conductive material for the housing 230 of the battery cell 120 can include a ceramic material (e.g., silicon nitride, silicon carbide, titanium carbide, zirconium dioxide, beryllium oxide, and among others) and a thermoplastic material (e.g., polyethylene, polypropylene, polystyrene, polyvinyl chloride, or nylon), among others.

The battery cell 120 can include at least one anode layer 245, at least one cathode layer 255, and an electrolyte layer 260 disposed within the cavity 250 defined by the housing 230. The anode layer 245 can receive electrical current into the battery cell 120 and output electrons during the operation of the battery cell 120 (e.g., charging or discharging of the battery cell 120). The anode layer 245 can include an active substance. The active substance can include, for example, an activated carbon or a material infused with conductive materials (e.g., artificial or natural Graphite, or blended), lithium titanate (Li₄Ti₅O₁₂), or a silicon-based material (e.g., silicon metal, oxide, carbide, pre-lithiated).

FIGS. 14A, 14B, and 14C are illustrative cross-sectional views of various battery cells 120. The battery cell 120 can be or include a prismatic battery cell 120. The prismatic battery cell 120 can have a housing 230 that defines a rigid enclosure (FIG. 14B). The housing 230 can have a polygonal base, such as a triangle, square, rectangle, pentagon, among others. For example, the housing 230 of the prismatic battery cell 120 can define a rectangular box. The prismatic battery cell 120 can include at least one anode layer 245, at least one cathode layer 255, and at least one electrolyte layer 260 disposed within the housing 230. The prismatic battery cell 120 can include a plurality of anode layers 245, cathode layers 255, and electrolyte layers 260. For example, the layers 245, 255, 260 can be stacked or in a form of a flattened spiral. The prismatic battery cell 120 can include an anode tab 265. The anode tab 265 can contact the anode layer 245 and facilitate energy transfer between the prismatic battery cell 120 and an external component. For example, the anode tab 265 can exit the housing 230 or electrically couple with a positive terminal 235 to transfer energy between the prismatic battery cell 120 and an external component.

The prismatic battery cell 120 (FIG. 14B) can also include a pressure vent 270. The pressure vent 270 can be disposed in the housing 230. The pressure vent 270 can provide pressure relief to the prismatic battery cell 120 as pressure increases within the prismatic battery cell 120. For example, gases can build up within the housing 230 of the prismatic battery cell 120. The pressure vent 270 can provide a path for the gases to exit the housing 230 when the pressure within the prismatic battery cell 120 reaches a threshold.

The present invention, thus generally described, will be understood more readily by reference to the following examples, which are provided by way of illustration and are not intended to be limiting of the present invention.

### EXAMPLES

### Example 1. Sacrificial Additive Materials for Producing Excess Li-Ions in

Rechargeable Batteries. Metal nitride (MNₓ) compounds were studied for possible use in conjunction with Li₃N as an additive in cathodes and anodes for lithium ion batteries. While Li₃N may serve as a Li reservoir, the metal nitrides described herein will assist in formation of a stable SEI on the electrode materials during the cell activation, electrolyte decomposition, and cycling. HF, formed during the electrolyte decomposition event, serves as an activation agent to transform MNₓ to MFₓ or Li-M-F compounds. The Li-M-F materials formed may be able to benefit in terms of ionic diffusivity in Li-ion batteries, when to compare with a binary MFₓ compound.

Table 1 summarizes a list of MNₓ candidate compounds that have been evaluated. The crystal structure and density of the compounds are also provided in Table 1.

TABLE 1
Crystal space group and density of MNₓ compounds.

| | Space | Density |
|---|---|---|
| MNₓ | group | [g/cc] |
| Si₃N₄ | P6₃/m | 3.134 |
| Ge₃N₄ | P31c | 5.118 |
| BN | P6₃/mmc | 1.956 |
| AlN | P6₃mc | 3.201 |
| InN | P6₃mc | 6.642 |
| Mg₃N₂ | la-3 | 2.662 |
| Sr₃N₂ | la-3 | 4.1 |
| Ca₃N₂ | la-3 | 2.606 |
| VN | P-6m2 | 6.239 |
| NbN | P-6m2 | 7.984 |
| TIN | Fm-3m | 5.34 |
| ZrN | Fm-3m | 7.099 |
| Ba₃N₂ | la-3 | 5.103 |
| NaN₃ | R-3m | 1.798 |
| KN₃ | I4/mcm | 1.908 |
| GaN | P6₃mc | 5.924 |

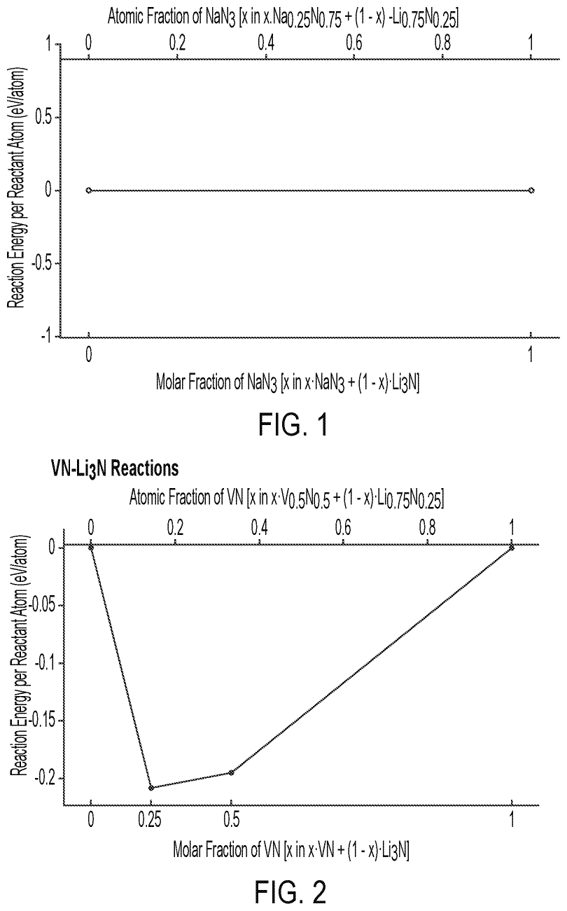

The chemical reactivity of the MNₓ compounds was evaluated vis-à-vis their calculated reactivity with Li₃N. As an example, FIG. 1 illustrates that NaN₃ will not react with Li₃N. This means that the two materials could potentially be used in a (nano-)composite mixture, where and they will remain phase-separated once deposited on the cathode surfaces. Ba₃N₂ and KN₃ also belong to this category, as noted in Table 2.

FIG. 2 shows the reaction between VN and Li₃N. Unlike NaN₃, 0.25 VN will react with 0.75 Li₃N to form 0.25 Li₇VN₄ and 0.5 Li⁺ ions with Eᵣₓₙ of −0.208 eV/atom at the local minimum point shown at x=0.25. This indicates that once VN and Li₃N are deposited as a coating at the cathode surface, they will react to release excess Li⁺ ions, while forming a new ternary Li₇VN₄ compound at the cathode surface. NbN, TiN, and ZrN also belong to this category, as noted in Table 2. Other metal nitrides that will form a ternary metal nitride compound upon the chemical reaction with Li₃N include Si₃N₄, Ge₃N₄, BN, AlN, InN, Mg₃N₂, Sr₃N₂, Ca₃N₂, and GaN, as noted in Tables 2 and 3.

TABLE 2
Metal nitride chemical stability with Li₃N

| Compound | Li₃N Stability | Eᵣₓₙ |
|---|---|---|
| Si₃N₄ | 0.333 Si₃N₄ + 0.667 Li₃N → Li₂SiN₂ | −0.272 |
| Ge₃N₄ | 0.333 Li₃N + 0.667 Ge₃N₄ → LiGe₂N₃ | −0.215 |
| BN | 0.5 Li₃N + 0.5 BN → 0.5 Li₃BN₂ | −0.171 |
| AlN | 0.5 AlN + 0.5 Li₃N → 0.5 Li₃AlN₂ | −0.135 |
| InN | 0.5 Li₃N + 0.5 InN → 0.5 Li₃InN₂ | −0.115 |
| Mg₃N₂ | 0.5 Mg₃N₂ + 0.5 Li₃N → 1.5 LiMgN | −0.058 |
| Sr₃N₂ | 0.5 Sr₃N₂ + 0.5 Li₃N → 1.5 SrLiN | −0.052 |
| Ca₃N₂ | 0.5 Ca₃N₂ + 0.5 Li₃N → 1.5 LiCaN | −0.047 |
| GaN | 0.5 GaN + 0.5 Li₃N → 0.5 Li₃GaN₂ | −0.129 |
| VN | 0.25 VN + 0.75 Li₃N → 0.25 Li₇VN₄ + 0.5 Li | −0.208 |
| NbN | 0.25 NbN + 0.75 Li₃N → 0.25 Li₇NbN₄ + 0.5 Li | −0.192 |
| TiN | 0.333 TiN + 0.667 Li₃N → 0.333 | −0.148 |
| | Li₅TiN₃ + 0.333 Li | |
| ZrN | 0.5 ZrN + 0.5 Li₃N → 0.5 Li₂ZrN₂ + 0.5 Li | −0.127 |
| Ba₃N₂ | No reaction | N/A |
| NaN₃ | No reaction | N/A |
| KN₃ | No reaction | N/A |

TABLE 3
Metal nitride classifications

| Type | Classification | Compounds |
|---|---|---|
| Type I | Does not react with Li₃N, | Ba₃N₂, NaN₃, KN₃ |
| | where Li₃N can serve as | |
| | excess Li source | |
| Type II | Forms Li-M-N ternary | VN, NbN, TiN, ZrN |
| | compounds and releasing Li | |
| | ions during the Li₃N reactions | |
| Type III | Forms Li-M-N ternary | Si₃N₄, Ge₃N₄, BN, AlN, InN, |
| | compounds | Mg₃N₂, Sr₃N₂, Ca₃N₂, GaN |

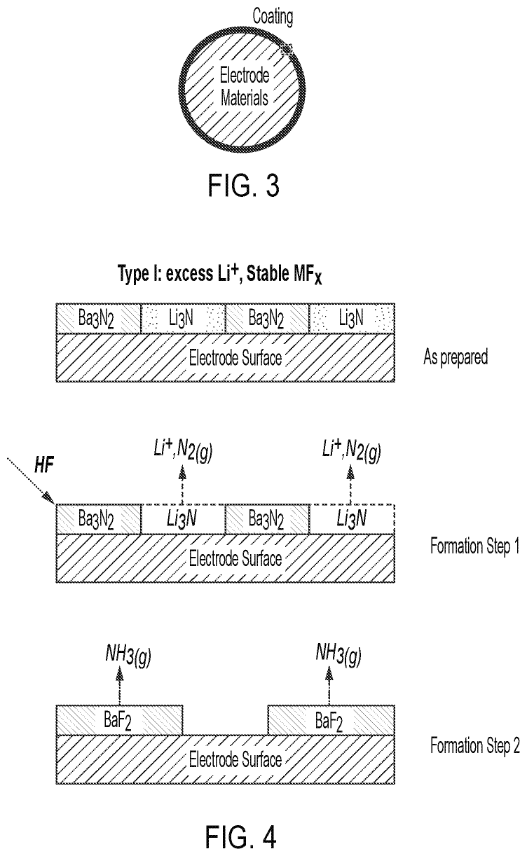

FIG. 3 is a schematic representation of the utilization of metal nitride materials with Li₃N on an electrode surface. This is only one example, showing a conformal type of coating, but the deposition conditions may depend on the synthesis techniques to be utilized. While it is desired to have the surface coating to be uniform, in one embodiment, the coating may be discontinuous in some selected regions that can facilitate Li⁺ ion diffusions from and toward the electrode. The interfacial stability between the coating and the electrode may vary depending on the chemical composition, stability, roughness, and/or synthesis/reaction conditions.

Type I Reactions.

FIG. 4 is a graphic representation of a three-step activation of a first type (Type I) of nitride materials, including Ba₃N₂, NaN₃, and KN₃. In this example, Ba₃N₂ and Li₃N are coated on the surface of an electrode. The as-prepared materials form a (nano-)composite on the surface. The actual morphology of the composite materials may be modified using different synthesis techniques. It is predicted (Table 2) that Ba₃N₂ and Li₃N do not react with each other. During the charging process (formation step 1), Li₃N will decompose to generate Li ions and N₂ gas. The Li ions can move toward the anode in order to compensate for the Li⁺ loss at the anode, due to the formation of an SEI layer. The N₂ gas may be released via a cell gas vent during the formation step. HF is formed in the liquid electrolyte when residual water/moisture is present to react with the LiPF₆ salt according to the equation: LiPF₆+H₂O↔POF₃+2HF+LiF. HF is a strong acid that can degrade subcomponents in a battery cell, thus avoiding HF generation, or quickly sequestering any generated HF, is a desirable feature. The surface coating materials are attacked by the HF, specifically reacting with the metal nitride materials, instead of reaching through to the underlying electrode materials. Similar to the reaction above, it is predicted that 0.143 Ba₃N₂ reacts with 0.857 HF to form 0.286 NH_{3(g)} and 0.429 BaF₂ with Eᵣₓₙ of −1.072 eV/atom. Just like N₂ gas, NH₃ gas may be released via the cell vent during the formation step. BaF₂ will act as a protective coating layer for the electrode materials. Similarly, NaN₃ and KN₃ will lead to the formation of protective metal fluorides, NaF and KF, respectively. Type I reactions are quite desirable to increase the excess amount of Li formed from the Li₃N component, and to form protective MFₓ species, after the activation of the cell. The Type I reactions with HF are illustrated in Table 4. The ratio of Li₃N and metal nitride can therefore vary from 0 to 1, as desired, since these two materials tend to phase separate.

TABLE 4
Type I metal nitride activation with HF during cell formation.

| Type I | HF Reactions | Eᵣₓₙ |
|---|---|---|
| Ba₃N₂ | 0.143 Ba₃N₂ + 0.857 HF → 0.286 NH3↑ + 0.429 BaF₂ | −1.072 |
| NaN₃ | 0.5 NaN₃ + 0.5 HF → 0.167 NH₃↑ + | −0.304 |
| | 0.5 NaF + 0.667 N₂↑ | |
| KN₃ | 0.5 HF + 0.5 KN₃ → 0.5 KF + 0.167 NH₃↑ + 0.667 N₂↑ | −0.294 |

Type II Reactions.

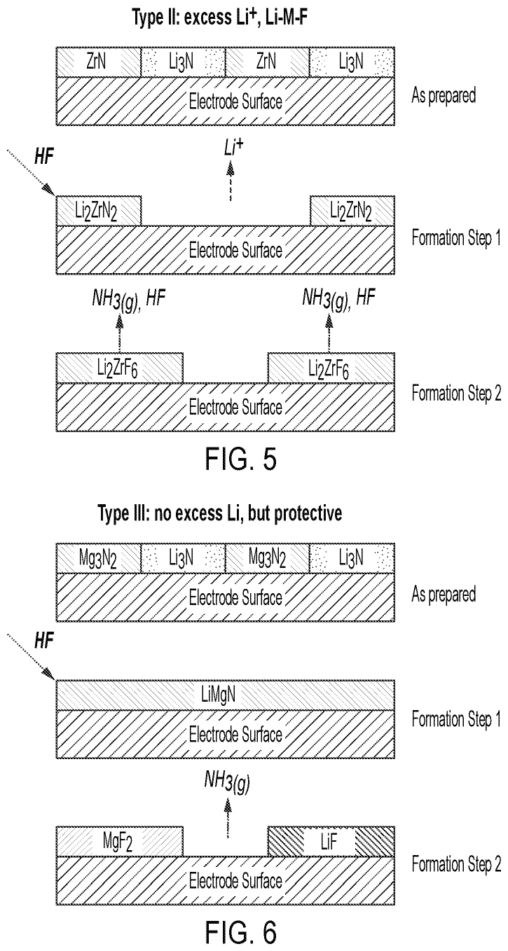

FIG. 5 is a graphic representation of the reaction pathways of Type II nitride materials. The Type II materials include VN, NbN, TiN, and ZrN. For FIG. 5, ZrN and Li₃N are initially coated on the electrode surface. As-prepared binary nitride materials react with one another at the surface of electrode, as described in Tables 2 and 3. This process will releases the Li ions. The Li ion can then compensate for Li⁺ ion loss due to the SEI formation at the anode. Another product of this reaction would be a ternary Li-M-N compound, such as Li₇VN₄, Li₇NbN₄, Li₅TiN₃, and Li₂ZrN₂ from VN, NbN, TiN, and ZrN, respectively.

Table 5 describes HF reactions of Li-M-N compounds. In the case of Li₂ZrN₂, it forms a stable Li₂ZrF₆ compound in addition to NH₃ gas. It is expected that Li₂ZrF₆ is ionically more conductive when to compared with metal fluoride materials. According to Table 2, the Li₃N to ZrN molar ratio should be about 1 or greater: i.e., the Li₃N:ZrN ratio may be 1:1, 2:1, 3:1, or greater. When the ratio between the Li₃N and ZrN is 1:1, formation of Li₂ZrF₆ is maximized, and can protect the electrode surface. If the ratio of Li₃N to ZrN is greater than 1, the excess amount of Li₃N may decompose to Li⁺ ions and N₂ gas. In the case of ZrN, incorporation on the cathode side may be beneficial due to the increased Li ionic conductivity.

In the case of Li₇VN₄, Li₇NbN₄, and Li₅TiN₃, all form NH₃ and N₂ gases that can be released by the cell vent system during the formation step. Another product of the Type II reactions is a very stable LiF protective layer. Li₇VN₄, Li₇NbN₄, and Li₅TiN₃ all produce a small amount of metal nitride as the product, VN, Nb₅N₆, and TiN, respectively. They may further react with the excess Li₃N to repeat the process, but this also means that higher amounts of Li₃N may be needed to consume all metal nitride reactants. The Li₃N to VN or NbN ratio, therefore, should be greater than 3:1; and the Li₃N to TiN ratio should be greater than 2:1.

TABLE 5
Type II metal nitride activation with HF during cell formation

| | | Eᵣₓₙ |
|---|---|---|
| Type II | HF reactions | _{(eV/atom)} |
| Li₇VN₄ | 0.125 Li₇VN₄ + 0.875 HF → 0.292 | −0.627 |
| | NH₃↑ + 0.875 LiF + 0.125 | |
| | VN + 0.041 N₂↑ | |
| Li₇NbN₄ | 0.875 HF + 0.125 Li₇NbN₄ → 0.025 | −0.639 |
| | Nb₅N₆ + 0.292 NH₃↑ + | |
| | 0.875 LiF + 0.030 N₂↑ | |
| Li₅TiN₃ | 0.834 HF + 0.166 Li₅TiN₃ → 0.277 | −0.654 |
| | NH₃↑ + 0.833 LiF + 0.166 | |
| | TiN + 0.028 N₂↑ | |
| Li₂ZrN₂ | 0.143 Li₂ZrN₂ + 0.857 HF → 0.143 | −0.596 |
| | Li₂ZrF₆ + 0.285 NH₃↑ | |

Type III Reactions.

Table 6 is a summary of the HF reactions for ternary Li-M-N compounds that are formed as a result of the reaction between the Li₃N and MNₓ, noted in Tables 2 and 3, i.e., Type III compounds. In the case of LiSrN, LiCaN, and LiMgN (derived from Sr₃N₂, Ca₃N₂, and Mg₃N₂), each is predicted to form a stable LiF phase with MF₂, and release NH₃ gas. Since the Type III reaction does not provide the excess Li, these material are desirable where the electrode surface needs chemical protection. The formation of both LiF and MF₂ may be desirable on the anode side for forming a more stable SEI layer. If excess Li ions were to be required to be produced and to be utilized at the cathode side, the molar ratio of Li₃N to Sr₃N₂, Ca₃N₂, or Mg₃N₂ may be greater than 1. See Table 2. An example of Mg₃N₂ reaction with Li₃N is illustrated in FIG. 6.

In the case of Li₃AlN₂ (derived from AlN) and LiGe₂N₃ (derived from Ge₃N₄), they lead to the formation of ternary Li₃AlF₆ and Li₂GeF₆ (along with Ge₅F₁₂), respectively. These compounds may be ionically more conductive than the MFₓ. They may be used if the electrode materials need to be protected with a Li-conducting fluoride material (similar to Li₂ZrF₆ case in Table 5), also suitable for protecting the cathode side. In the case of Ge₃N₄, the molar ratio of Li₃N:Ge₃N₄ would be 1:2 to produce the intermediate LiGe₂N₃. In the case of AlN, a molar ratio of Li₃N:AlN may be approximately 1:1 to produce Li₃AlN₂. In both cases, higher amounts of Li₃N may be used to produce the excess Li ions.

Li₃BN₂ (produced from BN) and Li₃GaN₂ (from GaN) lead to the formation of NH₃ gas, a stable LiF layer, and BN and GaN, respectively, similar to the Type II compounds of Table 4. In order to consume all of BN or GaN compounds, we suggest the ratio of Li₃N to BN or GaN to be greater than 1. See Table 2.

TABLE 6
Type III metal nitride activation with HF during cell formation

| | | Eᵣₓₙ |
|---|---|---|
| Type III | HF reactions | _{(eV/atom)} |
| LiSrN | 0.75 HF + 0.25 SrLiN → 0.25 NH₃↑ + | −0.967 |
| | 0.25 SrF₂ + 0.25 LiF | |
| LiCaN | 0.25 LiCaN + 0.75 HF → 0.25 NH₃↑ + | −0.913 |
| | 0.25 CaF₂ + 0.25 LiF | |
| LiMgN | 0.75 HF + 0.25 LiMgN → 0.25 NH₃↑ + | −0.785 |
| | 0.25 MgF₂ + 0.25 LiF | |
| Li₃AlN₂ | 0.857 HF + 0.143 Li₃AlN₂ → 0.143 | −0.670 |
| | Li₃AlF₆ + 0.286 NH₃↑ | |
| LiGe₂N₃ | 0.869 HF + 0.131 LiGe₂N₃ → 0.040 | −0.319 |
| | Ge₅F₁₂ + 0.066 Li₂GeF₆ + | |
| | 0.289 NH₃↑ + 0.053 N₂↑ | |
| Li₃BN₂ | 0.25 Li₃BN₂ + 0.75 HF → 0.25 NH₃↑ + | −0.642 |
| | 0.75 LiF + 0.25 BN | |
| Li₃GaN₂ | 0.75 HF + 0.25 Li₃GaN₂ → 0.25 NH₃↑ + | −0.661 |
| | 0.75 LiF + 0.25 GaN | |
| Li₃InN₂ | 0.167 Li₃InN₂ + 0.833 HF → 0.167 | −0.669 |
| | InH₅(NF)₂ + 0.5 LiF | |
| Li₂SiN₂ | 0.857 HF + 0.143 Li2SiN₂ → 0.143 | −0.536 |
| | SiH₆(NF₂)₂ + 0.286 LiF | |

### SUMMARY

Type I. Ba₃N₂, NaN₃, and KN₃.

The Type I materials do not chemically react with Li₃N. When activated by HF, they will form a stable BaF₂, NaF, and KF. A ratio of >0 to 1 between Li₃N and the Type I compound may be used, depending on the needs of excess Li ions to compensate for the loss on the anode side vs. protection on the cathode side. Type I materials would be most desired at the cathode electrode side.

Type II: VN, NbN, TiN, and ZrN.

The Type II materials form excess Li ions via reaction with Li₃N. They also form secondary, intermediate Li-M-N ternary nitride materials via reaction with Li₃N. In the case of Li₇VN₄, Li₇NbN₄, and Li₅TiN₃, they all produce a small amount of binary metal nitride as the side product, when reacting with HF. The ratio of Li₃N to VN or NbN may be greater than 3:1; and, a Li₃N to TiN ratio may be greater than 2:1, if utilized on the cathode side. This will help reduce the metal nitride that is formed and increases the excess Li⁺ ions to be supplied to the anode side. In the case of Li₂ZrN₂, it forms a stable Li₂ZrF₆ compound, likely more ionically conductive than binary metal fluorides. The molar ratio between Li₃N and ZrN should be greater than 1, and would be the best to use these on the cathode electrode side that can help with Li⁺ ion transport.

Type III: Li-M-N Ternary Compound Formation.

Sr₃N₂, Ca₃N₂, and Mg₃N₂ lead to the formation of LiF and MF₂, as a suitable species to protect anode SEI. If used on the cathode side to produce excess Li⁺ ions, the molar ratio of Li₃N to Sr₃N₂, Ca₃N₂, or Mg₃N₂ may be greater than 1. In the case of Li₃AlN₂ (derived from AlN) and LiGe₂N₃ (derived from Ge₃N₄), they lead to the formation of ternary Li₃AlF₆ and Li₂GeF₆ (along with Ge₅F₁₂), respectively. We expect the Li-M-F compounds to be more ionically conductive than binary metal fluoride compounds. In order to be utilized on the cathode side, the molar ratio of Li₃N:Ge₃N₄ may be greater than 1:2, and Li₃N:AlN may be greater than 1:1. Li₃BN₂ (produced from BN) and Li₃GaN₂ (from GaN) lead to the formation stable LiF layers, but a small amount of BN and GaN are produced as a byproduct. Therefore, the ratio of Li₃N to BN or GaN may be greater than 1 to consume metal nitride and to produce excess Li⁺ ions.

Preparation of Electrode Materials with Li₃N and MNₓ.

The targeted metal precursor chemicals containing MNₓ and Li₃N may be pre-mixed under a reducing environment (e.g., Ar or N₂ atmosphere). These materials, as an additive from 0.1 to 15 wt %, can be blended together with commercially available electrode materials including but not limited to LiFePO₄, NMC, LMNO, graphite, Si/SiOₓ, etc. The ratio of Li₃N and MNₓ can vary from 0 to 1. In another embodiment, the Li₃N content may be increased if further excess Li ions are desired. Similarly, if fewer excess Li ion are desired, the Li₃N content may be decreased.

The additive containing cathode/anode active materials will be mixed with conductive carbon and binder materials in N-methylpyrrolidone (NMP) solution, or other suitable solvent, to form a slurry. The slurry will be coated on to Al/Cu foil, and then dried in the oven to remove the solvent. The loading level of cathode materials may vary from 5 to 50 mg/cm² and the packing density can vary from 1.0 to 5.0 g/cc. These electrodes may be separated a layer of separator if liquid electrolyte is used. In the case of all solid-state batteries, polymer or solid-state electrolyte may be used.

Cathode active materials may include LiFePO₄, LiMnₓFe₁₋ₓPO₄, LiMn₂O₄, LiNi_{0.5}Mn_{1.5}O₄, Li(NiₐMn_{b}Co_{c}Al_{d})O₂ (where, a+b+c+d=1), or Li-rich Mn-rich layered oxide cathodes (e.g., Li₁₊ₓM₁₋ₓO₂), but are not limited to these cathode active materials. The anode materials may include Li metal, graphite, Si, SiOₓ, Si nanowire, lithiated Si, or mixture thereof. A traditional liquid electrolyte with LiPF₆ salt, dissolved in carbonate solutions may be used. In other embodiments, a solid-state electrolyte including but not limited to oxide, sulfide, or phosphates-based crystalline structure may replace the liquid electrolyte. The cell configuration may be prismatic, cylindrical, or pouch type. Each cell may be further configured together to design pack, module, or stack with desired power output.

The cell may undergo electrolyte filling, re-filling, charging, discharging, aging, high temperature storage, or a combination of any two or more thereof. In order to promote some MFₓ and Li-M-Fₓ, the moisture level of the electrode and/or liquid electrolyte materials may be controlled at the ppm level. In one embodiment, high Ni cathode materials may contain a surface Li salts that may promote the formation of H₂O, enough to form a small amount of HF to convert MNₓ or Li-M-N to MFₓ or Li-M-F. In another embodiment, nanosized LiFePO₄ may be aged at the ambient atmosphere, which can increase the water content from several hundred ppm to approximately 1,000 ppm or more.

### Example 2

Low Voltage Oxide Materials as Sacrificial Additives for Rechargeable Batteries. Ternary lithium metal oxide or phosphate (Li-M-O or Li-M-P—O, respectively) compounds at the battery cathode surface may release Li⁺ ions to account for loss of lithium in the battery due to SEI formation in a first, and subsequent, charging cycle, with the metal oxide or phosphate then forming binary oxide/phosphate coating phases. Contrary to the materials in Example 1, the ternary oxide/phosphate compounds do not require a separate degassing step when the Li⁺ ions are electrochemically extracted during the 1^{st} cycle formation cycle.

Here, a number of Li-M-O or Li-M-P—O compounds were initially identified having an average voltage from about 0.2 to 2.7 V vs. Li/Li⁺. Then, based upon the actual or predicted polymorphism, thermodynamic stability of the corresponding lithiated and de-lithiated species, and their decomposition products, the compounds of interest was further focused. Table 7 provides a summary the some of the Li-containing transition metal oxide/phosphate compounds that were initially evaluated. The table illustrates the chemical formula of the lithiated and de-lithiated species in the first column. For example, in the first row, Li₀₋₁Ti₈O₁₃ involves the reaction between Ti₈O₁₃ and LiTi₈O₁₃. The second column shows the Hall space group notation of a given compound. In this notation, rotation, translation, and axis direction symbols are separated and inversion centers are defined by the Hall symbols. The next column shows the average voltage between the lithiated and de-lithiated species. The ability to store Li⁺ ions is measured by its mass (i.e., gravimetric capacity) or volume (i.e., volumetric capacity) in the next two columns. The specific energy or energy density is a measure of how much energy the battery material contains in comparison to its weight or volume, respectively.

TABLE 7
List of Li—M—O or Li—M—P—O compounds with
low voltage (less than 2.7 V vs. Li/Li⁺)

| | | Voltage | Gravimetric | Volumetric | Specific | Energy |
|---|---|---|---|---|---|---|
| | | [V vs. | Capacity | Capacity | Energy | Density |
| Formula | Hall | Li/Li⁺] | [mAh/g] | [Ah/l] | [Wh/kg] | [Wh/L] |
| Li₀₋₁Ti₈O₁₃ | —R 3 | 0.54 | 45 | 181 | 24 | 98 |
| Li₀₋₁Fe₅O₈ | —R 3 2″ | 0.69 | 65 | 317 | 45 | 218 |
| Li₀₋₂Ti₁₃O₂₂ | —C 2bc 2 | 0.77 | 54 | 217 | 42 | 166 |
| Li₀₋₁TiPO₄ | —P 2ac 2n | 0.85 | 179 | 576 | 152 | 489 |
| Li₀₋₁Ti₃O₄ | —C 2 2 | 0.88 | 125 | 593 | 110 | 521 |
| Li_{1.6-2}CoO₂ | P 1 | 0.91 | 102 | 366 | 93 | 332 |
| Li_{0-0.75}TiO₂ | —P 4n 2n | 1.02 | 236 | 935 | 242 | 955 |
| Li_{0.5-2}VO₂ | —P 2yb | 1.12 | 415 | 1423 | 465 | 1595 |
| Li₀₋₁TiO₂ | —C 2y | 1.16 | 309 | 1126 | 359 | 1309 |
| Li_{0-0.75}TiO₂ | —P 2ac 2ab | 1.27 | 236 | 950 | 299 | 1201 |
| Li₁₋₂NbVO₄ | —I 2b 2 | 1.29 | 121 | 557 | 156 | 720 |
| Li_{0.5-1}TiO₂ | P 1 | 1.4 | 154 | 596 | 216 | 833 |
| Li₀₋₁TiO₂ | I 4bw | 1.43 | 309 | 1256 | 442 | 1796 |
| | 2bw 1bw | | | | | |
| Li_{0-0.75}TiO₂ | —P 2ac 2n | 1.44 | 236 | 891 | 341 | 1285 |
| Li₆₋₇CuO₄ | A 2 2ac | 1.62 | 152 | 421 | 247 | 684 |
| Li₀₋₁MoO₂ | —P 2 2n | 1.66 | 199 | 1046 | 329 | 1730 |
| Li_{0.75-1}TiO₂ | C 2y | 1.69 | 77 | 308 | 130 | 520 |
| Li_{8.5-10.5}Co₄O₉ | P 1 | 1.72 | 118 | 364 | 204 | 626 |
| Li₀₋₁TiO₂ | —R 3 2″ | 1.78 | 309 | 1206 | 551 | 2151 |
| Li₀₋₁TiO₂ | F 4d 2 3 1d | 1.84 | 309 | 1206 | 568 | 2220 |
| Li7-8BiO6 | P 1 | 1.85 | 74 | 299 | 137 | 552 |
| Li₄₋₅Ti₃O₈ | —C 2y | 1.93 | 88 | 302 | 169 | 582 |
| Li_{0-0.33}TiO₂ | P 1 | 1.95 | 109 | 422 | 212 | 821 |
| Li₅₋₆MnO₄ | A 2 2ac | 1.99 | 167 | 418 | 333 | 832 |
| Li₃₋₅V₇O₁₂ | C 2y | 2.06 | 92 | 392 | 189 | 808 |
| Li_{0.5-1.25}CrO₂ | C 2yc | 2.1 | 217 | 854 | 455 | 1791 |
| Li_{0-0.5}TiO₂ | P 6c 2c | 2.1 | 161 | 605 | 337 | 1269 |
| Li₀₋₁VPO₄ | —P 2ac 2n | 2.13 | 175 | 591 | 374 | 1259 |
| Li_{0-1.5}MnO₂ | F 4d 2 3 1d | 2.19 | 413 | 1570 | 906 | 3445 |
| Li_{0-0.5}WO₃ | —I 2 2 3 | 2.23 | 57 | 408 | 127 | 910 |
| Li_{4.5-6}FeO₄ | C 2y | 2.23 | 249 | 633 | 556 | 1415 |
| Li_{2.5-3.5}CoO₃ | P 1 | 2.23 | 204 | 596 | 456 | 1331 |
| Li_{7.5-8.5}CrO₆ | P 1 | 2.24 | 129 | 341 | 291 | 766 |
| Li₀₋₁VPO₄ | —C 2c 2 | 2.25 | 175 | 599 | 394 | 1348 |
| Li_{0.8-1.2}MnO₂ | P 1 | 2.3 | 113 | 405 | 259 | 933 |
| Li_{1.2-1.6}CoO₂ | P 1 | 2.34 | 105 | 347 | 246 | 812 |
| Li_{0-0.2}VO₂ | P 1 | 2.34 | 64 | 251 | 149 | 588 |
| Li_{2-3.5}CoO₃ | —P 2 2n | 2.34 | 306 | 933 | 715 | 2178 |
| Li_{0-1.25}VO₂ | I 4bw 1bw | 2.38 | 366 | 1414 | 869 | 3360 |
| Li_{0-0.67}VPO₄ | —R 3 2″c | 2.39 | 119 | 375 | 283 | 896 |
| Li_{0-0.92}MoO₂ | —C 2y | 2.41 | 183 | 925 | 442 | 2232 |
| Li_{0-0.5}VPO₄ | —P 2ac 2n | 2.46 | 90 | 301 | 220 | 739 |
| Li₀₋₁CrPO₄ | —P 2ac 2n | 2.46 | 174 | 581 | 428 | 1428 |
| Li_{4-5.88}CoO₄ | P 2yc | 2.47 | 307 | 814 | 758 | 2011 |
| Li₄₋₇Ti₁₁O₂₄ | P 1 | 2.5 | 84 | 297 | 210 | 743 |
| Li₄₋₆CoO₄ | P 2y | 2.6 | 326 | 872 | 847 | 2266 |
| Li₅₋₆NiO₄ | A 2 2ac | 2.65 | 163 | 439 | 433 | 1167 |

Polymorph and Thermodynamic Stability.

The materials from Table 7 in terms of thermodynamic stability, using a convex hull distance (Eₕᵤₗₗ). When a convex hull distance is a positive number, this means that there are more stable phase mixtures at this chemical composition. For example, Li₅Ti₃O₈ is predicted to decompose to Li₂TiO₃ and LiTiO₂, where the Eₕᵤₗₗ is 22 meV/atom. At room temperature k_{B}T=25 meV, the kinetic energy of any given molecule at room temperature is −36 meV, and therefore, any compound with Eₕᵤₗₗ less than ˜40 meV as defined as “nearly-stable” at room temperature conditions. In addition, some of materials listed in Table 7 are polymorphs (defined herein as when two or more crystalline phases, having different atomic arrangement in the solid state, have the same atomic content). For determining lithium transition metal oxides and phosphates of interest, only the lowest energy structure, also known as a ground state structure, was used for any polymorphic compounds. Table 8 is a list of lithiated compounds that were evaluated with regard to thermodynamic stability and polymorphism. The convex hull energy, crystal system, and space group of the candidate materials are listed in Table 8.

TABLE 8
List of lithiated compounds after thermodynamic stability and
polymorph evaluations.

| Lithiated Compound | Eₕᵤₗₗ [eV/atom] | Crystal System | Spacegroup |
|---|---|---|---|
| LiTiO₂ | 0 | Tetragonal | I41/amd |
| LiVPO₄ | 0 | Orthorhombic | Cmcm |
| LiMoO₂ | 0 | Trigonal | R-3m |
| Li₇Ti₁₁O₂₄ | 0 | Monoclinic | C2/m |
| Li₆MnO₄ | 0 | Tetragonal | P42/nmc |
| Li₆CoO₄ | 0 | Tetragonal | P42/nmc |
| LiCrPO₄ | 1 | Monoclinic | P21 |
| Li₅Ti₃O₈ | 22 | Trigonal | R-3m |
| Li₂CoO₂ | 39 | Trigonal | P-3m1 |
| Li₆FeO₄ | 24 | Tetragonal | P42/nmc |
| Li₈BiO₆ | 33 | Trigonal | R-3 |
| LiW₂O₆ | 34 | Orthorhombic | Immm |
| Li₆NiO₄ | 21 | Orthorhombic | Pmmm |

Voltage of Li Extraction.

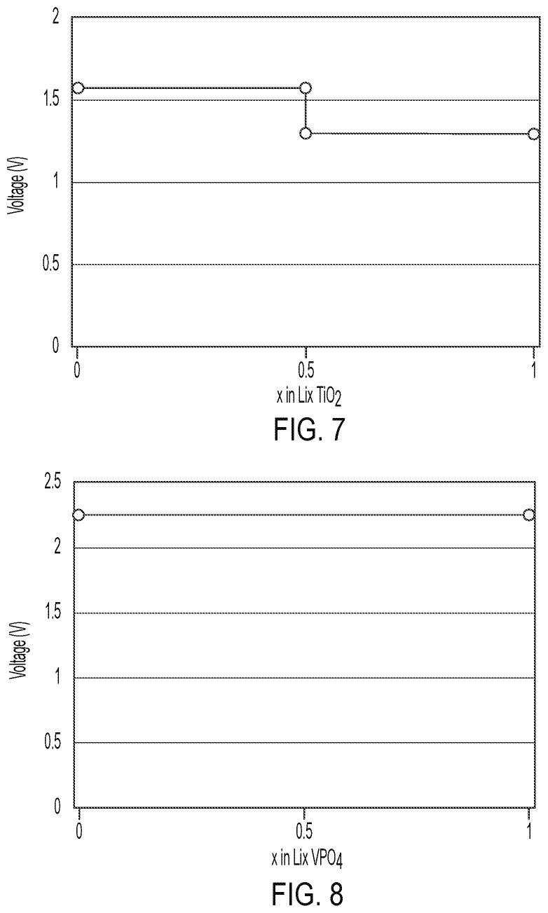

Table 9 summarizes the charging reaction of lithiated compounds listed in Table 8. The second column, “Net Reactions”, describes the overall Li chemical extraction reaction (i.e., charging reaction). For example, LiTiO₂ converts to TiO₂, giving one molar unit of Li per LiTiO₂ compound at 1.43 V vs. Li/Li⁺, as shown in the last column. However, this net reaction is composed of a two-step reaction: Li₁TiO₂→Li_{0.5}TiO₂→Li₀TiO₂, as shown in Table 9 and FIG. 7.

TABLE 9
Net chemical Li extraction reaction, reaction pathway, and
average voltage.

| | | | | Avg. |
|---|---|---|---|---|
| | | | | Voltage |
| Com- | | | Two Step | [vs. |
| pound | Net Reactions | #Step | (If any) | Li/Li⁺] |
| LiTiO₂ | LiTiO₂ → TiO₂ + Li | 2 | Li₁ → Li_{0.5} → | 1.43 |
| | | | Li₀ | |
| LiVPO₄ | LiVPO₄ → VPO₄ + Li | 1 | N/A | 2.25 |
| LiMoO₂ | LiMoO₂ → MoO₂ + Li | 1 | N/A | 1.66 |
| Li₇Ti₁₁O₂₄ | Li₇Ti₁₁O₂₄ →Li₄Ti₁₁O₂₄ + | 1 | N/A | 2.5 |
| | 3Li | | | |
| Li₆MnO₄ | Li₆MnO₄ → Li₅MnO₄ + Li | 1 | N/A | 1.99 |
| Li₆CoO₄ | Li₆CoO₄ → Li₄CoO₄ + 2Li | 2 | Li₆ → Li₅ → | 2.6 |
| | | | Li₄ | |
| LiCrPO₄ | LiCrPO₄ → CrPO₄ + Li | 1 | N/A | 2.46 |
| Li₅Ti₃O₈ | Li₅Ti₃O₈ → Li₄Ti₃O₈ + Li | 1 | N/A | 1.93 |
| Li₂CoO₂ | Li₂CoO₂ → Li_{1.6}CoO₂ + | 1 | N/A | 0.91 |
| | 0.4 Li | | | |
| Li₆FeO₄ | Li₆FeO₄ → Li_{4.5}FeO₄ + | 2 | Li₆ → Li_{5.25} → | 2.23 |
| | 1.5 Li | | Li_{4.5} | |
| Li₈BiO₆ | Li₈BiO₆ → Li₇BiO₆ + Li | 1 | N/A | 1.85 |
| LiW₂O₆ | LiW₂O₆ → 2WO₃ + Li | 2 | Li₁ → Li_{0.76} → | 2.23 |
| | | | Li₀ | |
| Li₆NiO₄ | Li₆NiO₄ → Li₅NiO₄ + Li | 1 | N/A | 2.65 |

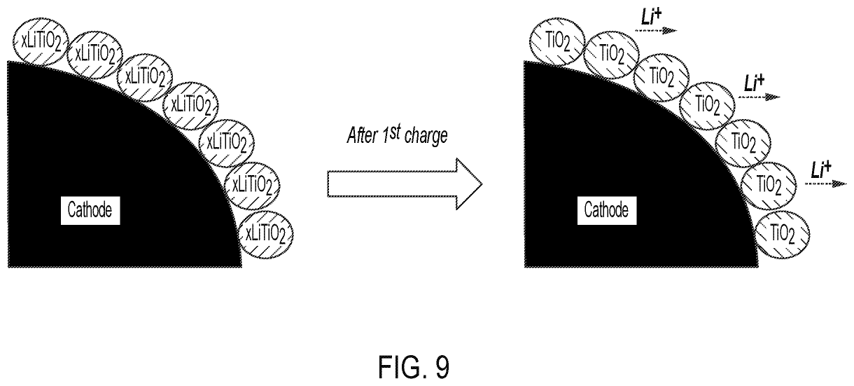

As shown in Table 9, few of the lithiated compounds, such as LiTiO₂, Li₆CoO₄, Li₆FeO₄, and LiW₂O₆, proceed via two-step reactions. The remaining materials undergo a one-step charging reaction, where the example for LiVPO₄ is shown in FIG. 9.

Charged Compound Stability Analysis.

Table 10 summarizes the chemical stability of delithiated compounds in Table 9. TiO₂, VPO₄, MoO₂, CrPO₄, Li₇BiO₆, WO₃, Li₅NiO₄ are thermodynamically stable, even after the Li extraction from the parent compound.

TABLE 10
Stability and decomposition reaction of delithiated species.

| Delithiated | E_{Hull} | |
|---|---|---|
| Compound | [eV/atom ] | Secondary Decomposition |
| TiO₂ | 0 | Stable |
| VPO₄ | 0 | Stable |
| MoO₂ | 0 | Stable |
| Li₄Ti₁₁O₂₄ | 38 | Li₄Ti₅O₁₂ + TiO₂ |
| Li₅MnO₄ | 41 | LiMnO₂ + Li₂O |
| Li₄CoO₄ | 91 | Li₂CoO₃ + Li₂O |
| CrPO₄ | 0 | Stable |
| Li₄Ti₃O₈ | 61 | Li₄Ti₅O₁₂ + Li₂TiO₃ |
| Li_{1.6}CoO₂ | 47 | Li₁₀Co₄O₉ + LiCoO₂ + |
| | | CoO |
| Li_{4.5}FeO₄ | 101 | Li₂O₂ + Li₂FeO₃ + |
| | | Li₅FeO₄ |
| Li₇BiO₆ | 0 | Stable |
| WO₃ | 0 | Stable |
| Li₅NiO₄ | 0 | Stable |

Other compounds in Table 10 tend to decompose to more stable phase mixtures, where some of these compounds are known experimentally. For example, Li₄Ti₁₁O₂₄ decomposes to Li₄Ti₅O₁₂ (anode material at 1.5 V vs. Li/Li⁺) and TiO₂. Li₅MnO₄ decomposes to LiMnO₂ (an approximately 3 V cathode material), Li₄Ti₃O₈ decomposes to Li₄Ti₅O₁₂ anode and Li₂TiO₃ (4.5 V cathode material), Li_{1.6}CoO₂ decomposes to LiCoO₂ (3.7 V cathode material), and Li_{4.5}FeO₄ decomposes to Li₅FeO₄ (an approximately 3-4 V material) and Li₂FeO₃ (an approximately 4 V cathode material), respectively. Some high voltage cathode materials may additionally contribute to increasing the energy density of the battery cell, especially during cell degradation/cycling.

Materials Selection.

Material selection and evaluation is summarized in Table 11 based on thermodynamic stability, average voltage, utilized Li percentage, delithiated species stability, and decomposition products.

TABLE 11
Materials selection and evaluation.

| | | Voltage | | | De- |
|---|---|---|---|---|---|
| Com- | Thermodynamic | [vs. | % of | Delithiated | composition |
| pound | Stability | Li/Li⁺] | Li use | Stability | Products |
| LiTiO₂ | Stable | 1.43 | 100% | 0 | Stable |
| LiVPO₄ | Stable | 2.25 | 100% | 0 | Stable |
| LiMoO₂ | Stable | 1.66 | 100% | 0 | Stable |
| Li₇Ti₁₁O₂₄ | Stable | 2.5 | 42.9% | 38 | Acceptable |
| Li₆MnO₄ | Stable | 1.99 | 16.7% | 41 | Acceptable |
| Li₆CoO₄ | Stable | 2.6 | 33.3% | 91 | Acceptable |
| LiCrPO₄ | Stable | 2.46 | 100% | 0 | Stable |
| Li₅Ti₃O₈ | Nearly-stable | 1.93 | 20% | 61 | Acceptable |
| Li₂CoO₂ | Nearly-stable | 0.91 | 20% | 47 | Li₁₀Co₄O₉ |
| Li₆FeO₄ | Nearly-stable | 2.23 | 25% | 101 | Acceptable |
| Li₈BiO₆ | Nearly-stable | 1.85 | 12.5% | 0 | Acceptable |
| LiW₂O₆ | Nearly-stable | 2.23 | 100% | 0 | Acceptable |
| Li₆NiO₄ | Nearly-stable | 2.65 | 16.7% | 0 | Acceptable |

Of the materials listed in Table 11, a number of the compounds were found to be stable and have acceptable stability for use in battery materials.

As noted, the lithium transition metal oxides and phosphates, upon initial charging and subsequent cycles, produce lithium ions that can balance out the cell capacity and account for some lithium loss to SEI formation. FIG. 9 is an illustration of this process using the examples of LiTiO₂, which produces the Li⁺ and then forms a protective TiO₂ coating on the active material surface.

Procedure.

A metal-containing precursor chemical solution may be prepared that upon sintering will produce lithium transition metal oxides or phosphates. This method may include, but is not limited to, co-precipitation methods using a continuously stirred tank reactor (CSTR). The solution may be further mixed with cathode materials including, but not limited to, NMC811, LiFePO₄, Mn-substituted LiMnₓMn₁₋ₓPO₄ (LMFP), NMC, and LMNO cathode materials (NMC811, NMC, and LMNO are abbreviations for various phases of lithium nickel manganese (cobalt) cathode active materials), or precursors to such materials, at room temperature or elevated temperature with an aging time from 5 min to 24 hours. The pH of the solution may be controlled by the presence of acid or base in order to precipitate well-mixed precursor compounds. The mixture may then be annealed at elevated temperatures. Illustrative elevated temperatures may include any of the following values, or a range of any two of the following values: 200, 400, 600, 800, and 1,000° C. The aging time may be any of the following values or in a range of any two of the following values: 1, 2, 3, 4, 8, 12, 16, 24, 36, 48, 60, and 72 hours. Depending on the choice of coatings, reducing/oxidizing conditions may vary by presence of different gas agents including but not limited to N₂, O₂, Air, Ar, H₂, CO, CO₂, mixture thereof, etc. The materials may include a thin coating layer at the outer surface in the form of an island or a conformal coating.

Particles of Li-M-O or Li-M-P—O cathode additives, of varying sizes, may be synthesized via solid-state methods. They may exhibit primary and secondary particle sizes (i.e. a drupelet structure where the large particles are the secondary size and the smaller particles are the primary size). The primary particle size range may any of the following values or in a range of any two of the following values: 5, 10, 15, 20, 25, 30, 35, 40, 50, 60, 70, 80, 90, 100, 110, 120, 130, 140, 150, 160, 170, 180, 190, 200, 300, 400, 500, 600, 700, 800, 900 nm. One method of performing solid-state synthesis is a high-energy ball-milling (or, bead-mill) process. The solid-state method may be followed by an optional spray dryer processing step to facilitate the drying and secondary particle formation. The optimal amount of cathode additives and its chemical composition at the electrode material surface may be tuned by the secondary heat-treatment conditions may be any of the following values or in a range of any two of the following values: 200, 400, 600, 800, and 1,000° C. in the presence of reducing gas agents such as N₂, Ar, H₂, or gas mixture thereof. In another embodiment, secondary heat treatment is not applied.

Metal precursor chemicals containing Li-M-O or Li-M-P—O can prepared and blended with the cathode materials. These materials may be added at an amount of about 1 to 10 wt %, when mixed together with commercially-available electrode materials. If additional excess Li ions are desired, Li₃N, or other metal nitrides as above, may be used as an additional cathode additive.

In some embodiments, the cathode and/or anode active materials may be mixed with conductive carbon and/or binder materials in a solvent to form a slurry. The slurry may then be coated onto a current collector and dried in the oven to remove the solvent. The loading level of cathode materials may vary from 5 to 50 mg/cm² on the current collector, and the packing density may vary from 1.0 to 5.0 g/cc. The anodes and cathodes will be separated by a layer of a separator.

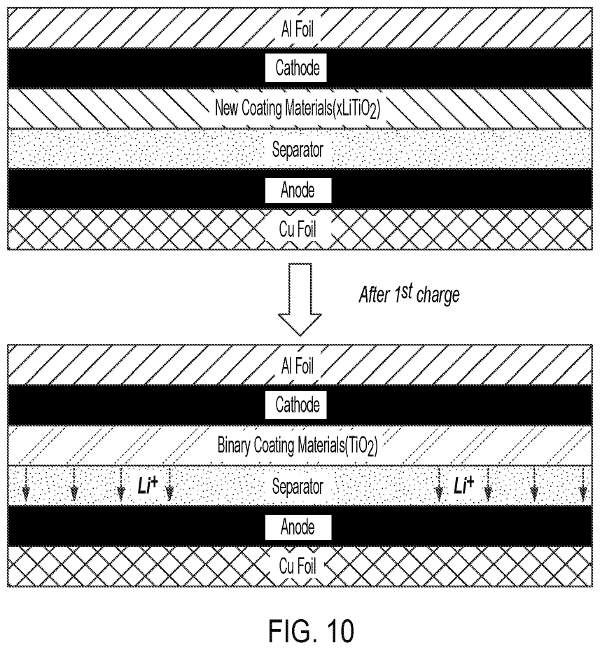

Illustrative cathode active materials may include LiFePO₄, LiMnₓFe₁₋ₓPO₄, LiMn₂O₄, LiNi_{0.5}Mn_{1.5}O₄, Li(NiₐMn_{b}Co_{c}Al_{d})O₂ (where, a+b+c+d=1), or Li-rich Mn-rich layered oxide cathodes (e.g., Li₁₊ₓM₁₋ₓO₂), but are not limited to these cathode active materials. Anode active materials may include Li metal, graphite, Si, SiOₓ, Si nanowire, lithiated Si, or mixture of any two or more thereof. A traditional liquid electrolyte with a salt such as, but not limited to, LiPF₆ salt, and based upon carbonate solvents may be used. In other embodiments, a solid-state electrolyte may be used. Solid-state electrolytes include oxide, sulfide, or phosphate-based crystalline structures may replace the liquid electrolyte. The cell configuration may be prismatic, cylindrical, or pouch type. Each cell can further configured together to design pack, module, or stack with desired power output. An illustration of cathode and anode stacks is shown in FIG. 10.

The cell may undergo extensive formation process which include electrolyte filling, re-filling, charging, discharging, aging, high temperature storage, and mixture thereof. In order to promote formation of MFₓ and Li-M-Fₓ, the moisture level of the electrode and/or liquid electrolyte materials may be controlled at ppm level. In one embodiment, high Ni cathode materials may contain lithium salts that the surface to promote the formation of H₂O, and enough to form a small amount of HF to convert MNK or Li-M-N to MFₓ or Li-M-F. In another embodiment, nanosized LiFePO₄ may be aged at the ambient atmosphere, increasing the water content from several hundred ppm to 1,000 ppm or more.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions that can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. An electrode comprising an electrode active material and a lithium generating species comprising a mixture of Li₃N and MNₓ, wherein MNₓ is a metal nitride including a metal (M) selected from Na, K, Ca, Mg, Ba, V, Nb, Ti, Zr, and Sr, or a mixture of any two or more thereof.

2. The electrode of claim 1, wherein the MNₓ comprises Ba₃N₂, NaN₃, KN₃, VN, NbN, TiN, ZrN, Sr₃N₂, Ca₃N₂, or Mg₃N₂, or a mixture of any two or more thereof.

3. The electrode of claim 2, wherein MNₓ comprises Ba₃N₂, NaN₃, or KN₃, or a mixture of any two or more thereof.

4. The electrode of claim 3, wherein a molar ratio of Li₃N to MNₓ is from greater than 0 to 1.

5. The electrode of claim 2, wherein MNₓ comprises VN, NbN, TiN, or ZrN, or a mixture of any two or more thereof.

6. The electrode of claim 3, wherein a molar ratio of Li₃N to MNₓ is greater than 2.

7. The electrode of claim 2, wherein MNₓ comprises Sr₃N₂, Ca₃N₂, or Mg₃N₂, or a mixture of any two or more thereof.

8. The electrode of claim 3, wherein a molar ratio of Li₃N to MNₓ is from greater than 0.5 but less than 10.

9. A battery comprising the electrode of claim 1, a counter electrode, and an electrolyte comprising a halogen-containing species.

10. The battery of claim 9, wherein the halogen-containing species is a fluoride-containing compound.

11. The battery of claim 10, wherein the fluoride-containing compound is HF.

12. An electrode comprising an electrode active material and coating of a ternary lithium metal oxide, a ternary lithium transition metal phosphate, or a mixture thereof, wherein the metal of the ternary lithium metal oxide comprises Ti, Mo, Mn, Co, Fe, Bi, W, or Ni, or a mixture of any two or more thereof; and the transition metal of the ternary lithium transition metal phosphate comprises V or Cr, or a mixture thereof.

13. The electrode of claim 12, wherein the ternary lithium metal oxide comprises LiTiO₂, LiMoO₂, Li₇Ti₁₁O₂₄, Li₆MnO₄, Li₆CoO₄, Li₅Ti₃O₈, Li₂CoO₂, Li₆FeO₄, Li₈BiO₆, LiW₂O₆, or Li₆NiO₄, or a mixture of any two or more thereof.

14. The electrode of claim 12, wherein the ternary lithium transition metal phosphate comprises LiVPO₄ or LiCrPO₄, or a mixture of any two or more thereof.

15. The electrode of claim 12, wherein the coating comprises LiTiO₂, LiMoO₂, LiVPO₄, or LiCrPO₄, or a mixture of any two or more thereof.

16. A battery comprising:
an anode;
an electrolyte comprising a halogen-containing species; and,
a cathode comprising a cathode active material and a lithium generating species comprising a mixture of Li₃N and MNₓ,
wherein MNₓ is a metal nitride including a metal (M) selected from Na, K, Ca, Mg, Ba, V, Nb, Ti, Zr, and Sr, or a mixture of any two or more thereof.

17. The battery of claim 16, wherein the halogen-containing species is a fluoride-containing compound.

18. The battery of claim 17, wherein the fluoride-containing compound is HF.

19. A method of producing an electrode having a protective coating, the method comprising:
forming in a liquid medium a slurry comprising an electrode active material and a lithium generating species comprising a mixture of Li₃N and MNₓ, wherein MNₓ is a metal nitride including a metal (M) selected from Na, K, Ca, Mg, Ba, V, Nb, Ti, Zr, and Sr, or a mixture of any two or more thereof;
applying the slurry to a current collector;
removing the liquid medium to form an electrode;
immersing the electrode in an electrolyte comprising a halogen-containing species; and
applying a voltage to the electrode to generate an electrode having a protective coating;
wherein:
protective coating comprises a reaction product of the Li₃N, MNₓ, and the halogen-containing species; and
the protective coating is electrically insulating and ionically conductive.

20. The method of claim 19, wherein the halogen-containing species is HF.
